(19) United States
(12) Patent Application Publication
(10) Pub. No.: US 2025/0153987 A1
(43) Pub. Date: May 15, 2025

(54) METHOD AND SYSTEM FOR CONTROLLING A ROTATION SPEED OF A TURNTABLE AND AERIAL WORK PLATFORM

(71) Applicant: Lingong Heavy Machinery Co., Ltd., Shandong (CN)

(72) Inventors: Zhongli Zhao, Shandong (CN); Dehong Wang, Shandong (CN); Haoren Zhou, Shandong (CN); Lei Wang, Shandong (CN)

(21) Appl. No.: 18/031,817

(22) PCT Filed: Oct. 12, 2022
(86) PCT No.: PCT/CN2022/124738

§ 371 Date: Feb. 3, 2025

(30) Foreign Application Priority Data
Oct. 12, 2021 (CN) 202111186313.7

(51) Int. Cl. B66F 11/04; B66F 17/00

(52) U.S. Cl. CPC B66F 11/046; B66F 17/006

(57) ABSTRACT

Provided are a method and system for controlling a rotation speed of a turntable and an aerial work platform. The method includes the following: When a boom is in the unfolded state, the rotational angular velocity ω of the turntable is equal to ω₀−k₁(α−α₀) when the luffing angle α of the boom is greater than or equal to α₀ and the length L of the boom is less than L₀. α₀ is a set constant of the luffing angle of the boom, L₀ is a set constant of the length of the boom, and k₁ is an angular velocity coefficient for luffing control of the boom. The rotational angular velocity w of the turntable is equal to ω₀−k₂(L−L₀) when the luffing angle α of the boom is less than α₀ and the length L of the boom is greater than or equal to L₀. k₂ is an angular velocity coefficient for elongation control of the boom. The rotational angular velocity ω of the turntable is equal to MIN{ω₀−k₁(α−α₀), ω₀−k₂(L−L)} when the luffing angle α of the boom is greater than or equal to α₀ and the length L of the boom is greater than or equal to L₀.

### CROSS-REFERENCE TO RELATED APPLICATION(S)

This is a national stage application filed under 35 U.S.C. 371 based on International Patent Application No. PCT/CN2022/124738, filed Oct. 12, 2022, which claims priority to Chinese Patent Application No. 202111186313.7, filed on Oct. 12, 2021, the disclosure of which is incorporated herein by reference in its entirety.

### TECHNICAL FIELD

The present application relates to the field of aerial work platform technologies, for example, a method and system for controlling a rotation speed of a turntable and an aerial work platform.

### BACKGROUND

For a rotary aerial work platform, a turntable is generally connected to a chassis by a rotary support and driven by a rotary motor to rotate.

The rotational angular velocity is generally set to two levels. The rotational angular velocity is set to a high speed when the overall unit is in the stowed state. When the luffing angle and the elongation length of a boom reach set values, the state of the boom is defined as an unfolded state, and at this time the rotational angular velocity switches from the high speed to a low speed. For an operator on an aerial work platform, when the boom is in the unfolded state, the operator is prone to dizziness and the impact of rotary braking when the boom is at a position in which the luffing angle of the boom is larger or the elongation length of the boom is longer. When the boom is at a position in which the luffing angle of the boom is smaller or the elongation length of the boom is shorter, the rotation efficiency of the turntable is low and the operation time of the operator is short.

### SUMMARY

The present application provides a method and system for controlling a rotation speed of a turntable.

An embodiment provides a method for controlling a rotation speed of a turntable. The boom is disposed on the turntable. The boom includes a stowed state and an unfolded state. The method for controlling the rotation speed of the turntable includes the following: When the boom is in the unfolded state, the rotational angular velocity ω of the turntable is determined to be equal to ω₀−k₁(α−α₀) in response to the luffing angle α of the boom being greater than or equal to go and the length L of the boom being less than L₀. α₀ is a set constant of the luffing angle of the boom, L₀ is a set constant of the length of the boom, and k₁ is an angular velocity coefficient for luffing control of the boom. The rotational angular velocity ω of the turntable is determined to be equal to ω₀−k₂(L−L₀) in response to the luffing angle α of the boom being less than go and the length L of the boom being greater than or equal to L₀. k₂ is an angular velocity coefficient for elongation control of the boom. The rotational angular velocity ω of the turntable is determined to be equal to MIN{ω₀−k₁(α−α₀), ω₀−k₂(L−L₀)} in response to the luffing angle α of the boom being greater than or equal to α₀ and the length L of the boom being greater than or equal to L₀.

An embodiment provides a system for controlling a rotation speed of a turntable. The system includes a computer-readable storage medium and a control unit. The computer-readable storage medium stores a program for the method for controlling the rotation speed of the turntable according to any preceding solution. The control unit is configured to perform the program for the method for controlling the rotation speed of the turntable according to any preceding solution.

An embodiment provides an aerial work platform. The platform includes any preceding system for controlling the rotation speed of the turntable.

### BRIEF DESCRIPTION OF DRAWINGS

FIG. 1 is a view of an aerial work platform according to an embodiment of the present application.

FIG. 2 is a flowchart of a method for controlling a rotation speed of a turntable according to an embodiment of the present application.

### REFERENCE LIST

1 turntable
2 boom
3 rotary motor
4 speed reducer
5 rotary support
6 multi-way valve
7 angle sensor
8 pull cord displacement sensor
9 chassis

### DETAILED DESCRIPTION

In the description of the present application, it is to be noted that orientations or position relations indicated by terms such as “center”, “upper”, “lower”, “left”, “right”, “vertical”, “horizontal”, “in”, and “out” are orientations or position relations based on the drawings. These orientations or position relations are intended only to facilitate the description of the present application and simplify the description and not to indicate or imply that a device or element referred to must have such specific orientations or must be configured or operated in such specific orientations. Thus, these orientations or position relations are not to be construed as limiting the present application. Additionally, terms such as “first” and “second” are used merely for the description and are not to be construed as indicating or implying relative importance. Terms “first position” and “second position” are two different positions.

Unless otherwise expressly specified and limited, the term “installation”, “connected to each other”, “connected” or “secured” is to be construed in a broad sense, for example, as securely connected or detachably connected, mechanically connected or electrically connected, directly connected to each other or indirectly connected to each other via an intermediary, or internally connected between two elements or interaction relations between two elements. For those of ordinary skill in the art, specific meanings of the preceding terms in the present application may be construed according to specific circumstances.

Unless otherwise expressly specified and limited, when a first feature is described as “above” or “below” a second feature, the first feature and the second feature may be in direct contact or be in contact via another feature between the two features instead of being in direct contact. Moreover, when the first feature is described as “on”, “above” or “over” the second feature, the first feature is right on, above, or over the second feature or the first feature is obliquely on, above, or over the second feature, or the first feature is simply at a higher level than the second feature. When the first feature is described as “under”, “below”, or “underneath” the second feature, the first feature is right under, below, or underneath the second feature or the first feature is obliquely under, below, or underneath the second feature, or the first feature is simply at a lower level than the second feature.

The solutions of the present application are described hereinafter through embodiments in conjunction with the drawings.

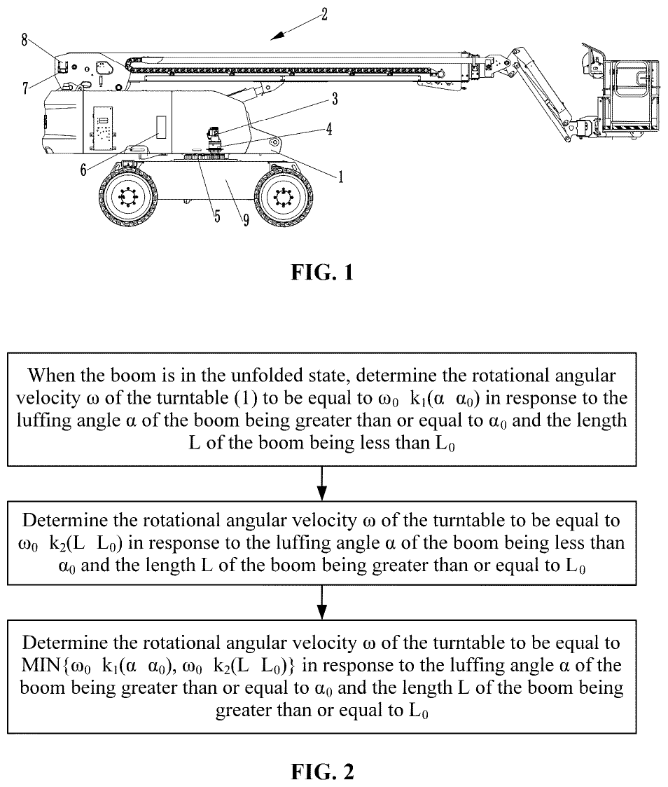

As shown in FIG. 1, an embodiment provides a system for controlling a rotation speed of a turntable for an aerial work platform. The system includes a turntable 1, a chassis 9, a computer-readable storage medium, a control unit, and a rotation actuator unit. A boom 2 is disposed on the turntable 1. The turntable 1 is rotatable relative to the chassis 9. The computer-readable storage medium stores a program for a method for controlling a rotation speed of a turntable. The control unit is configured to perform the program for the method for controlling the rotation speed of the turntable. The rotation actuator unit includes a rotary motor 3, a speed reducer 4, a rotary support 5, and a multi-way valve 6. The rotary support 5 is secured to the chassis 9. The rotary motor 3 is secured to the rotary support 5. The rotary support 5 includes an inner ring and an outer ring. The outer ring is fixedly connected to the chassis 9. The inner ring is fixedly connected to the rotary motor 3. The rotary motor 3 drives, through the speed reducer 4, the inner ring and the outer ring of the rotary support 5 to rotate relative to each other, thereby driving the turntable 1 to rotate relative to the chassis 9. The multi-way valve 6 is connected to a rotary cylinder. A rotary coupling in the multi-way valve 6 receives a control signal from the control unit and adjusts the opening degree of a valve core of the rotary coupling, thereby controlling the output flow of the rotary cylinder and the rotational speed of the rotary motor 3.

The turntable 1 includes the boom 2. The boom 2 includes a first boom and a second boom. The first boom is secured to the turntable 1, the second boom is connected to the first boom in a sleeved manner, and the second boom is retractable with respect to the first boom. In this embodiment, the first boom can rotate relative to the turntable 1 so that the boom 2 is at a preset angle with respect to a horizontal plane, which is referred to as the luffing angle of the boom 2. The first boom is driven by a luffing cylinder so that the first boom rotates relative to the turntable 1 to change the luffing angle of the boom 2. In an embodiment, the multi-way valve 6 is connected to the luffing cylinder. A luffing coupling in the multi-way valve 6 receives a control signal from the control unit to adjust the opening degree of a valve core of the luffing coupling, thereby controlling the output flow of the luffing cylinder, and achieving the change of the luffing angle of the boom 2.

The second boom may be retractable with respect to the first boom to change the length of the boom 2. Moreover, a third boom is fixedly connected to an end of the second boom facing away from the first boom, and a fourth boom is fixedly connected to an end of the third boom facing away from the second boom. The need for a variable length of the boom 2 is met by setting up the third boom and the fourth boom. The second boom is driven by a telescopic cylinder to change the length of the boom 2. In an embodiment, the multi-way valve 6 is connected to the telescopic cylinder. A telescopic coupling in the multi-way valve 6 receives a control signal from the control unit to adjust the opening degree of a valve core of the telescopic coupling, thereby controlling the output flow of the telescopic cylinder, and achieving the change of the length of the boom 2.

In an embodiment, the system for controlling the rotation speed of the turntable also includes a boom luffing angle detection unit and a boom length detection unit. The boom luffing angle detection unit is configured to detect the luffing angle α of the boom 2, the boom length detection unit is configured to detect the length L of the boom 2, and the boom luffing angle detection unit and the boom length detection unit are communicatively connected to the control unit. In this embodiment, the boom luffing angle detection unit transmits the detected luffing angle of the boom 2 to the control unit in real time, and the boom length detection unit transmits the detected length of the boom 2 to the control unit in real time. Based on the received luffing angle of the boom 2, the received length of the boom 2, and the method for controlling the rotation speed of the turntable that is stored therein, the control unit controls the angle of rotation of the turntable 1 driven by a hydraulic motor.

In an embodiment, the boom luffing angle detection unit includes an angle sensor 7, two angle sensors 7 are provided, and the two angle sensors 7 are disposed on two sides of the first boom one to one. In this embodiment, the angle sensors 7 are disposed on two sides of the first boom one to one and are secured to an end of the first boom facing away from the second boom. Before detection, the two angle sensors 7 display the same angle through calibration. The arrangement of the two angle sensors 7 can achieve two-way verification and ensure the accuracy of detection of the luffing angle of the boom 2.

The angle sensors 7 are angle sensors that output a current value in an analog quantity, and an output signal is a current signal and has a linear relationship with the luffing angle of the boom 2. The range of the output current signal is 4 mA to 20 mA, and the range of the measurement angle is −45° to +90°.

In this embodiment, an alarm is also provided in the system for controlling the rotation speed of the turntable, and the alarm is electrically connected to the control unit. When the difference between angles displayed by the two angle sensors 7 and received by the control unit exceeds a set difference, the control unit controls the alarm to raise an alarm. The set difference is not limited here and may be set by those skilled in the art according to practical situations.

In an embodiment, the boom length detection unit includes a pull cord displacement sensor 8, and the pull cord displacement sensor 8 includes a sensor body and a pull cord. The sensor body is secured to an end of the first boom facing away from the second boom, a first end of the pull cord is secured to the sensor body, and a second end of the pull cord is connected to an end of the second boom facing away from the first boom.

The output signal of the pull cord displacement sensor 8 is an analog current signal, which has a linear relationship with the length of the pull cord. The range of the output current signal is 4 mA to 20 mA and the range of the measurement length is 0 m to 8 m.

The control unit is communicatively connected to the angle sensors 7 and the pull cord displacement sensor 8 separately. The angle sensors 7 obtain the luffing angle of the boom 2 by measuring a rotation angle of the first boom relative to the turntable 1, and the luffing angle of the boom 2 is sent to the control unit. The pull cord displacement sensor 8 calculates the length of the boom 2 by measuring an elongation length of the second boom relative to the first boom. A calculation formula of the length of the boom 2 is stored in the control unit, and the control unit calculates the length of the boom 2 based on the received signal from the pull cord displacement sensor 8 and the calculation formula of the length of the boom 2 stored in the control unit.

In an embodiment, the control unit is electrically connected to the rotation actuator unit and is configured to control the rotation actuator unit to operate. The method for controlling the rotation speed of the turntable is stored in the control unit, and the control unit controls the operation of the turntable 1 based on the received luffing angle of the boom 2, the calculated length of the boom 2, and the method for controlling the rotation speed of the turntable stored therein.

In this embodiment, the system for controlling the rotation speed of the turntable also includes a display screen, which is a human-computer interaction interface, through which an operator can set multiple parameters and a control signal can be transmitted to the rotation actuator unit.

In this embodiment, the hydraulic principle of hydraulic circuits of the aerial work platform, the electrical connection manner in which the control unit is connected to the rotation actuator unit and the display screen separately, and the working principle of the control unit may refer to the relevant art, and details are not described herein.

When the boom 2 is in the unfolded state, the system for controlling the rotation speed of the turntable can control the rotational angular velocity of the turntable 1 based on the luffing angle of the boom 2 and the elongation length of the boom 2, so that the turntable 1 has an appropriate angular velocity at different working positions and operator comfort and efficiency are improved.

An embodiment provides an aerial work platform. The platform uses the preceding system for controlling the rotation speed of the turntable, thereby improving the stability and safety of the aerial work platform, reducing the work time of an operator, and improving operator comfort and efficiency.

As shown in FIG. 2, an embodiment provides a method for controlling a rotation speed of a turntable. The method is applied to the preceding system for controlling the rotation speed of the turntable. The boom 2 has a stowed state and an unfolded state. When the boom 2 is in the stowed state, the luffing angle α of the boom 2 is less than go, and the length L of the boom 2 is less than L₀. α₀ is a set constant of the luffing angle of the boom 2, L₀ is a set constant of the length of the boom 2, and the rotational angular velocity ω of the turntable 1 is equal to ω₀.

In this embodiment, α₀=5° (corresponding to the radian 0.0872 rad), L₀=0.6 m, and the rotational angular velocity ω₀ in the stowed state is equal to 0.078 rad/s.

In an embodiment, a current value corresponding to the rotational angular velocity is controlled and calibrated according to actual measurements. Of course, in other embodiments, the set constant α₀ of the luffing angle of the boom 2 and the set constant L₀ of the length of the boom 2 may be set according to the type and specification of the aerial work platform.

When the boom 2 is in the unfolded state, if the luffing angle α of the boom 2 is greater than or equal to α₀ and the length L of the boom 2 is less than L₀, the rotational angular velocity ω of the turntable 1 is ω₀−k₁(α−α₀), where k₁ is an angular velocity coefficient for luffing control of the boom 2.

If the luffing angle α of the boom 2 is less than α₀ and the length L of the boom 2 is greater than or equal to L₀, the rotational angular velocity ω of the turntable 1 is ω₀−k₂(L−L₀), where k₂ is an angular velocity coefficient for elongation control of the boom 2.

If the luffing angle α of the boom 2 is greater than or equal to α₀ and the length L of the boom 2 is greater than or equal to L₀, the rotational angular velocity ω of the turntable 1 is MIN{w₀−k₁(α−α₀), ω₀−k₂(L−L₀)}.

According to the method for controlling the rotation speed of the turntable provided in this embodiment, when the boom 2 is in the unfolded state, the rotational angular velocity of the turntable 1 is controlled by two variables, namely, the luffing angle of the boom 2 and the length of the boom 2, which are independent variables, and the rotational angular velocity takes a smaller value of the two. Thus, it is ensured that when the boom 2 is in the unfolded state and the turntable 1 rotates, the rotational angular velocity of the turntable 1 is controlled based on the change of the luffing angle of the boom 2 and the change of the elongation length of the boom 2. When the luffing angle of the boom 2 is larger and the elongation length of the boom 2 is longer, the dizziness of the operator and the impact of rotary braking are reduced. When the luffing angle of the boom 2 is smaller and the elongation length of the boom 2 is shorter, the rotation efficiency is improved and the operation time is reduced.

In an embodiment, the angular velocity coefficient k₁ for luffing control of the boom 2 is 1.47, and the angular velocity coefficient k₂ for elongation control of the boom 2 is 0.15.

In an embodiment, in the process in which the boom 2 switches from the stowed state to the unfolded state: in response to the luffing angle α of the boom 2 first reaching α₀, the rotational angular velocity ω of the turntable 1 is equal to ω₀−k₁(α−α₀) when the length L of the boom 2 is less than L₀, and the rotational angular velocity ω of the turntable 1 is equal to MIN{ω₀−k₁(α−α₀), ω₀−k₂(L−L₀)} when the length L of the boom 2 is greater than or equal to L₀. That is, if the luffing angle α of the boom 2 first reaches 5° (0.0872 rad), the rotational angular velocity ω of the turntable 1 is equal to 0.078−1.47*(α−0.0872) when the length L of the boom 2 is less than 0.6 m, and the rotational angular velocity ω of the turntable 1 is equal to MIN{0.078−1.47*(α−0.0872), 0.078−0.15*(1−0.6)} when the length L of the boom 2 is greater than or equal to 0.6 m.

In response to the length L of the boom 2 first reaching L₀, the rotational angular velocity ω of the turntable 1 is equal to ω₀−k₂(α−α₀) when the luffing angle α of the boom 2 is less than α₀, and the rotational angular velocity ω of the turntable 1 is equal to MIN{ω₀−k₁(α−α₀), ω₀−k₂(L−L₀)} when the length a of the boom 2 is greater than or equal to α₀. That is, if the length L of the boom 2 first reaches 0.6 m, the rotational angular velocity ω of the turntable 1 is equal to 0.078−0.15*(L−0.6) when the length α of the boom 2 is less than 5° (0.0872 rad), and the rotational angular velocity ω of the turntable 1 is equal to MIN{0.078−1.47*(α−0.0872), 0.078−0.15*(L−0.6)} when the luffing angle α of the boom 2 is greater than or equal to 5° (0.0872 rad).

In an embodiment, in the process in which the boom 2 switches from the unfolded state to the stowed state: when the luffing angle α of the boom 2 is greater than or equal to α₀ and the length L of the boom 2 is greater than or equal to L₀, the rotational angular velocity ω of the turntable 1 is equal to MIN{ω₀−k₁(α−α₀), ω₀−k₂(L−L₀)}. That is, if the luffing angle α of the boom 2 is greater than or equal to 5° (0.0872 rad) and the length L of the boom 2 is greater than or equal to 0.6 m, the rotational angular velocity ω of the turntable 1 is equal to MIN{0.078−1.47*(α−0.0872), 0.078−0.15*(L−0.6)}.

In response to the luffing angle α of the boom 2 first reaching α₀, the rotational angular velocity ω of the turntable 1 is equal to ω₀−k₂(L−L₀) when the length L of the boom 2 is greater than or equal to L₀, and the rotational angular velocity ω of the turntable 1 is equal to ω₀ when the length L of the boom 2 is less than L₀. That is, if the luffing angle α of the boom 2 first reaches 5° (0.0872 rad), the rotational angular velocity ω of the turntable 1 is equal to 0.078−0.15*(1−0.6) when the length L of the boom 2 is greater than or equal to 0.6 m, and the rotational angular velocity of the turntable 1 is 0.078 rad/s when the length L of the boom 2 is less than 0.6 m.

In response to the length L of the boom 2 first reaching L₀, the rotational angular velocity ω of the turntable 1 is equal to ω₀−k₁(α−α₀) when the luffing angle α of the boom 2 is greater than or equal to α₀, and the rotational angular velocity ω of the turntable 1 is ω₀ when the luffing angle α of the boom 2 is less than α₀. That is, if the length L of the boom 2 first reaches 0.6 m, the rotational angular velocity ω of the turntable 1 is equal to 0.078−1.47*(α−0.0872) when the luffing angle α of the boom 2 is greater than or equal to 5° (0.0872 rad), and the rotational angular velocity o of the turntable 1 is equal to do that is 0.078 rad/s when the luffing angle α of the boom 2 is less than 5° (0.0872 rad).

1. A method for controlling a rotation speed of a turntable, a boom being disposed on the turntable, the boom comprising a stowed state and an unfolded state, and the method comprising:
when the boom is in the unfolded state, determining a rotational angular velocity ω of the turntable to be equal to ω₀−k₁(α−α₀) in response to a luffing angle α of the boom being greater than or equal to α₀ and a length L of the boom being less than L₀, wherein α₀ is a set constant of the luffing angle of the boom, L₀ is a set constant of the length of the boom, and k₁ is an angular velocity coefficient for luffing control of the boom;
determining the rotational angular velocity ω of the turntable to be equal to ω₀−k₂(L−L₀) in response to the luffing angle α of the boom being less than α₀ and the length L of the boom being greater than or equal to L₀, wherein k₂ is an angular velocity coefficient for elongation control of the boom; and
determining the rotational angular velocity ω of the turntable to be equal to MIN{ω₀−k₁(α−α₀), ω₀−k₂(L−L₀)} in response to the luffing angle α of the boom being greater than or equal to α₀ and the length L of the boom being greater than or equal to L₀.

2. The method for controlling the rotation speed of the turntable according to claim 1, further comprising: in a process in which the boom switches from the stowed state to the unfolded state,
in response to the luffing angle α of the boom first reaching α₀, determining the rotational angular velocity ω of the turntable to be equal to ω₀−k₁(α−α₀) in response to the length L of the boom is less than L₀; and determining the rotational angular velocity ω of the turntable to be equal to MIN{ω₀−k₁(α−α₀), ω₀−k₂(L−L₀)} in response to the length L of the boom is greater than or equal to L₀; and
in response to the length L of the boom first reaching L₀, determining the rotational angular velocity ω of the turntable to be equal to ω₀−k₂(α−α₀) in response to the luffing angle α of the boom being less than α₀; and determining the rotational angular velocity ω of the turntable to be equal to MIN{ω₀−k₁(α−α₀), ω₀−k₂(L−L₀)} in response to the luffing angle α of the boom being greater than or equal to α₀.

3. The method for controlling the rotation speed of the turntable according to claim 1, further comprising: in a process in which the boom switches from the unfolded state to the stowed state,
in response to the luffing angle α of the boom being greater than or equal to α₀ and the length L of the boom being greater than or equal to L₀, determining the rotational angular velocity ω of the turntable to be equal to MIN{ω₀−k₁(α−α₀), ω₀−k₂(L−L₀)};
in response to the luffing angle α of the boom first reaching α₀, determining the rotational angular velocity ω of the turntable to be equal to ω₀−k₂(L−L₀) in response to the length L of the boom being greater than or equal to L₀; and determining the rotational angular velocity ω of the turntable to be equal to ω0 in response to the length L of the boom being less than L₀; and
in response to the length L of the boom first reaching L₀, determining the rotational angular velocity ω of the turntable to be equal to ω₀−k₁(α−α₀) in response to the luffing angle α of the boom being greater than or equal to ω₀; and determining the rotational angular velocity ω of the turntable to be equal to ω₀ in response to the luffing angle α of the boom being less than α₀.

4. The method for controlling the rotation speed of the turntable according to claim 1, wherein when the boom is in the stowed state, determining the rotational angular velocity ω of the turntable to be equal to ω₀ in response to the luffing angle α of the boom being less than α₀ and the length L of the boom being less than L₀.

5. The method for controlling the rotation speed of the turntable according to claim 1, wherein the angular velocity coefficient k₁ for the luffing control of the boom is 1.47, and the angular velocity coefficient k₂ for the elongation control of the boom is 0.15.

6. A system for controlling a rotation speed of a turntable, comprising a computer-readable storage medium and a control unit, wherein the computer-readable storage medium stores a program for the method for controlling the rotation speed of the turntable according to claim 1, and the control unit is configured to perform the program for the method for controlling the rotation speed of the turntable according to any one of claim 1.

7. The system for controlling the rotation speed of the turntable according to claim 6, comprising a boom luffing angle detection unit and a boom length detection unit, wherein the boom luffing angle detection unit is configured to detect the luffing angle α of the boom, the boom length detection unit is configured to detect the length L of the boom, and the boom luffing angle detection unit and the boom length detection unit are communicatively connected to the control unit.

8. The system for controlling the rotation speed of the turntable according to claim 7, wherein the boom comprises a first boom and a second boom, the first boom is secured to the turntable, the second boom is connected to the first boom in a sleeved manner, and the second boom is retractable with respect to the first boom.

9. The system for controlling the rotation speed of the turntable according to claim 8, wherein the boom luffing angle detection unit comprises two angle sensors that are disposed on two sides of the first boom one to one.

10. The system for controlling the rotation speed of the turntable according to claim 8, wherein the boom length detection unit comprises a pull cord displacement sensor, the pull cord displacement sensor comprises a sensor body and a pull cord, the sensor body is secured to an end of the first boom facing away from the second boom, a first end of the pull cord is secured to the sensor body, and a second end of the pull cord is connected to an end of the second boom facing away from the first boom.

11. The system for controlling the rotation speed of the turntable according to claim 6, further comprising a rotation actuator unit, the control unit is electrically connected to the rotation actuator unit, and the control unit is configured to control the rotation actuator unit to operate.

12. An aerial work platform, comprising the system for controlling the rotation speed of the turntable according to claim 6.

13. A system for controlling a rotation speed of a turntable, comprising a turntable and a control unit, wherein a boom is disposed on the turntable, the boom comprises a stowed state and an unfolded state, and the control unit is configured to perform the following:
when the boom is in the unfolded state, determining a rotational angular velocity ω of the turntable to be equal to ω₀−k₁(α−α₀in response to a luffing angle α of the boom being greater than or equal to α₀ and a length L of the boom being less than L₀, wherein α₀ is a set constant of the luffing angle of the boom, L₀ is a set constant of the length of the boom, and k₁ is an angular velocity coefficient for luffing control of the boom;
determining the rotational angular velocity ω of the turntable to be equal to ω₀−k₂(L−L₀) in response to the luffing angle α of the boom being less than α₀ and the length L of the boom being greater than or equal to L₀, wherein k₂ is an angular velocity coefficient for elongation control of the boom; and
determining the rotational angular velocity ω of the turntable to be equal to MIN{ω₀−k₁(α−α₀), ω₀−k₂(L−L₀)} in response to the luffing angle α of the boom being greater than or equal to α₀ and the length L of the boom being greater than or equal to L₀.

14. The system for controlling the rotation speed of the turntable according to claim 13, further comprising a boom luffing angle detection unit and a boom length detection unit, wherein the boom luffing angle detection unit is configured to detect the luffing angle α of the boom, the boom length detection unit is configured to detect the length L of the boom, and the boom luffing angle detection unit and the boom length detection unit are communicatively connected to the control unit.

15. The system for controlling the rotation speed of the turntable according to claim 14, wherein the boom comprises a first boom and a second boom, the first boom is secured to the turntable, the second boom is connected to the first boom in a sleeved manner, and the second boom is retractable with respect to the first boom.

16. The system for controlling the rotation speed of the turntable according to claim 15, wherein the boom luffing angle detection unit comprises two angle sensors that are disposed on two sides of the first boom one to one.

17. The system for controlling the rotation speed of the turntable according to claim 15, wherein the boom length detection unit comprises a pull cord displacement sensor, the pull cord displacement sensor comprises a sensor body and a pull cord, the sensor body is secured to an end of the first boom facing away from the second boom, a first end of the pull cord is secured to the sensor body, and a second end of the pull cord is connected to an end of the second boom facing away from the first boom.

18. The system for controlling the rotation speed of the turntable according to claim 13, further comprising a rotation actuator unit, the control unit is electrically connected to the rotation actuator unit, and the control unit is configured to control the rotation actuator unit to operate.

19. An aerial work platform, comprising a system for controlling a rotation speed of a turntable, wherein the system comprises a turntable and a control unit, wherein a boom is disposed on the turntable, the boom comprises a stowed state and an unfolded state, and the control unit is configured to perform the following:
when the boom is in the unfolded state, determining a rotational angular velocity ω of the turntable to be equal to ω₀−k₁(α−α₀) in response to a luffing angle α of the boom being greater than or equal to α₀ and a length L of the boom being less than L₀, wherein α₀ is a set constant of the luffing angle of the boom, L₀ is a set constant of the length of the boom, and k₁ is an angular velocity coefficient for luffing control of the boom;
determining the rotational angular velocity ω of the turntable to be equal to ω₀−k₂(L−L₀) in response to the luffing angle α of the boom being less than α₀ and the length L of the boom being greater than or equal to L₀, wherein k₂ is an angular velocity coefficient for elongation control of the boom; and
determining the rotational angular velocity ω of the turntable to be equal to MIN{ω₀−k₁(α−α₀), ω₀−k₂(L−L₀)} in response to the luffing angle α of the boom being greater than or equal to α₀ and the length L of the boom being greater than or equal to L₀.
